(19) United States
(12) Patent Application Publication
(10) Pub. No.: US 2023/0003212 A1
(43) Pub. Date: Jan. 5, 2023

(54) COMPRESSOR SYSTEM FOR A RAIL VEHICLE, AND METHOD FOR CONTROLLING A COOLING DEVICE OF A COMPRESSOR SYSTEM

(71) Applicant: KNORR-BREMSE SYSTEME FOR SCHIENENFAHRZEUGE GMBH, Munich (DE)

(72) Inventors: Thomas MERKEL, Hurth (DE); Martin SCHMID, Munich (DE); Adrian KRAMLICH, Munich (DE); Ehsan AFSHAR, Munich (DE); Michael WINKLER, Munich (DE)

(21) Appl. No.: 17/780,475

(22) PCT Filed: Nov. 11, 2020
(86) PCT No.: PCT/EP2020/081758

§ 371 Date: May 26, 2022

(30) Foreign Application Priority Data
Nov. 26, 2019 (DE) 10 2019 131 921.8

(51) Int. Cl. F04B 49/06; F04B 49/20; F04B 41/00; F04B 39/06

(52) U.S. Cl. CPC F04B 49/065; F04B 49/20; F04B 41/00; F04B 39/066; B60L 2200/26

(57) ABSTRACT

The invention relates to a compressor system for a rail vehicle, having: a compressor, a cooling device and a control device or an interface for receiving control signals of a control device, wherein the control device is configured to actuate the cooling device independently of the operation of the compressor, and to be able to provide a variable cooling fluid volumetric flow rate, in particular a cooling air volumetric flow rate, which can be specified by way of the control device as an actuating variable.

### CROSS REFERENCE AND PRIORITY CLAIM

This patent application is a U.S. National Phase of International Patent Application No. PCT/EP2020/081758 filed Nov. 11, 2020, which claims priority to German Patent Application No. 10 2019 131 921.8, the disclosure of which being incorporated herein by reference in their entireties.

### FIELD

Disclosed embodiments relate to a compressor system for a rail vehicle, to a method for controlling a cooling device of a compressor system, and to a computer program product provided for this purpose.

### BACKGROUND

Compressors are used in numerous technical applications. In modern rail vehicles, as an example of such an area of use, the reduction of noise emissions is of ever-increasing importance. At the same time, it is necessary to ensure the thermal efficiency of the compressor in the entire temperature range, in the case of rail vehicles for example between −40° C. and +50° C., and also in tight installation spaces.

Conventional compressor systems of compressed-air compressors in rail vehicles comprise a compressor and possibly a post-cooler or, as in the case of two-stage piston compressors, an intermediate cooler and a post-cooler. The compressor may be designed as a piston machine or else as a rotary compressor, for example as a screw compressor or scroll compressor, and is predominantly air-cooled. Here, the air cooling is realized via fans, such as for example one or more fans or electric fans that are operated, by way of mechanical coupling or coupling in terms of signaling, in a manner corresponding to the compressor rotational speed.

However, in the case of high ambient temperatures and unfavorable spatial conditions, overheating of the compressor nevertheless frequently occurs. Conversely, due to this direct coupling, there is the risk, due to the high cooling power, thus, introduced, of internal ice formation or condensate accumulations and associated operational restrictions, and also increased wear and increased corrosion, in the case of low intake temperatures and short operating durations. This results in a conflict of objectives, which cannot be resolved by way of conventional cooling systems owing to the coupling of the cooler fan rotational speed to the compressor rotational speed.

### SUMMARY

In view of the above statements, disclosed embodiments provide a compressor system, a method for controlling a cooling device of a compressor system, and a computer program product for carrying out the method that make possible improved cooling of the compressor system. This is achieved by a compressor system, a method for controlling a cooling device of a compressor system, and a computer program product as claimed, with advantageous refinements detailed in the dependent claims.

### BRIEF DESCRIPTION OF THE FIGURES

Disclosed embodiments will be discussed in more detail below based on an embodiment with reference to the appended figures. In the figures, specifically:

FIG. 1 shows a schematic illustration of a compressor system according to a first embodiment,

FIG. 2 shows a schematic illustration of a compressor system according to a second embodiment,

FIG. 3 shows a schematic illustration of a compressor system according to a third embodiment,

FIG. 4 shows an exemplary open-loop control of a cooling device, which can be applied to a compressor system as per FIGS. 1 to 3,

FIG. 5 shows an exemplary closed-loop control of a cooling device, which can be applied to a compressor system as per FIGS. 1 to 3.

### DETAILED DESCRIPTION

Disclosed embodiments provide a compressor system that has a compressor, a cooling device, and a control apparatus or an interface for receiving control signals of a control apparatus, wherein the control apparatus is configured to control the cooling device independently of the operation, in particular of the rotational speed, of the compressor.

The cooling device of the compressor system can, thus, be operated in a manner matched to the cooling power required for optimum operation, independently of a compressor rotational speed of the compressor. This may be implemented via a separate control in terms of signaling of a stand-alone, energetic drive of the cooling device and/or, for example, also through the use of shiftable transmission ratios in the case of mechanical coupling of the cooling device to the compressor. Separate control in terms of signaling of the cooling device moreover offers the advantage that, in such a case, the control is also independent of whether the compressor is in principle switched on or off.

Here, separate control in terms of signaling does not necessarily require separate control apparatuses for the compressor and the cooling device, but rather is aimed at independent signal transmission and independent signal content. Such independence is not limited in that, with the signal generation for controlling the cooling device, possibly also compressor operating states are taken into account. For example, control, which is in principle independent, can be realized, wherein however, from a specific compressor rotational speed, at least a basic operation of the cooling device is provided.

The operation of the cooling device may be realized via a separate control in terms of signaling, wherein, in operating states in which the compressor is operated in parallel with the cooling device, a mechanical coupling to the compressor rotational speed can support the operation of the cooling device. In this sense, the control of the cooling device is still independent, wherein the coupling provides merely a selectable drive function or drive support.

As a result of the control of the cooling device that is independent of the operation of the compressor, the cooling device can be activated and deactivated according to requirement. In this way, overheating and/or condensate accumulations can be avoided or at least reduced. In particular, such a cooling device can be used in a preventive manner in recurring operational situations.

Consequently, the compressor system, in particular the compressor itself, can be operated at the optimum operating point. This not only has a positive effect on the efficiency and service life of the compressor system, but also allows overloading of a downstream dryer due to excessively high dryer entry temperatures to be avoided, whereby it is also the case that the efficiency of the dryer and the service life of the drying means are increased.

The cooling device is moreover configured to be able to provide a variable cooling-fluid volumetric flow rate, in particular a cooling-air volumetric flow rate, which can be predefined as a manipulated variable by the control apparatus.

In this context, it should be noted that the control apparatus is not restricted to purely open-loop control of the cooling device, but, beyond this, according to configuration, may also be aimed at closed-loop control. This is then the case if a corresponding controlled variable is monitored and compared. Where the term “control” is used, this may also include closed-loop control, that is to say be extended accordingly, if for example corresponding detection units have been, or are, provided, unless this is ruled out.

The cooling device, thus, has an adaptation device, which can vary a fluid volume provided for cooling per unit of time. For example, for this purpose corresponding control of a flow rate of a fluid via a valve position or a generation rate via a drive power, such as a flow rate according to a fan rotational speed, is possible. Owing to its good availability, the use of air as coolant constitutes a simple and inexpensive solution. Even if air is not used solely as coolant, it is possible, at least by way of variation of the air flow rate, for the cooling to adapted in a simple manner.

Alternatively or additionally, it is also possible for the cooling-fluid temperature and/or the switch-on and switch-off instants of the cooling device to be used as manipulated variable.

The compressor system may be of simplified construction if the compressor system comprises no separate control apparatus for controlling the cooling device and/or the compressor, but merely an interface for receiving a corresponding external control apparatus.

In one configuration of the compressor system, the control apparatus is a central control apparatus, in particular an inverter, of the compressor system, or the compressor system has an interface for receiving control signals of a central control apparatus of the rail vehicle.

In the case of a central control apparatus of a rail vehicle, further influencing factors may be taken into account for the control of the cooling device and/or of the compressor. A central intelligence may also include self-learning functionalities in order to speed up, to refine and/or, with regard to further functional components of the rail vehicle, to coordinate the reaction behavior according to certain boundary conditions. Self-learning functionalities of the control apparatus allow unfavorable operating situations to be avoided if the compressor is operated for example with a low switch-on duration and the switch-on duration and switch-on behavior of the cooling device are optimized in such a way that the mean temperature is optimized via the switch-on operations. In this regard, the cooling device can be activated for the first time, for example, when the minimum temperature of a relevant component that is required for optimum (low-wear) operation is attained and the cooling power is subjected to closed-loop control based on one or more relevant process parameters, such as the temperature and/or the pressure. The above statements relating to the central control apparatus of the rail vehicle apply analogously to the central control apparatus of the compressor system. For the purpose of taking into account further influencing factors which are not provided directly via the central control apparatus of the compressor system, it is possible for provision to be made according to requirement of corresponding interfaces for receiving corresponding input signals.

In one configuration, the compressor system has a temperature detection unit for detecting an air temperature and/or oil temperature and/or component temperature, wherein the control apparatus is configured to control the cooling device based on a temperature detected by the temperature detection unit, in particular based on an air temperature, oil temperature and/or component temperature.

Accordingly, the adaptation of the manipulated variable is realized in the form of a closed-loop control based on at least one temperature signal. Via the temperature measurement, direct conclusions regarding the probability of overheating and/or condensate formation can be drawn, so that, for example in a manner dependent on limit values stored in the control apparatus or other algorithms, manipulated-variable adaptation can be performed. A corresponding temperature detection unit may comprise one or more temperature sensors.

Through the measurement of the component temperature, moreover, it is possible not only for a general overheating and/or condensate-formation risk to be detected and counteracted, but also for the component temperature to be monitored with regard to excessive wear and aging, for example of elastomers, bearing greases, piston rings or other materials sensitive to temperature-induced aging. Even if no actual overheating occurs, the temperature data of the component can be documented in order for maintenance intervals based thereon to be adapted. This applies equally to the measurement of the oil temperature.

Alternatively or additionally, however, it is also possible for use to be made, for the closed-loop control of the cooling device, of other measurement variables, which correlate with a probability of overheating and/or condensate formation. With regard to condensate formation or a corresponding probability, use may also be made for example of a moisture sensor.

In one refinement, the compressor system comprises a post-cooler and/or an intermediate cooler that are/is arranged downstream of the compressor in the flow direction of the air flowing through the compressor, and the control apparatus is configured to control the cooling device based on a post-cooler exit temperature and/or an intermediate-cooler exit temperature of the air and/or an oil-sump temperature.

Through the measurement of the post-cooler exit temperature and/or the intermediate-cooler exit temperature of the air, the cooling power of the post-cooler and/or of the intermediate cooler, which, for example in the case of two-stage compressors, is arranged downstream of the first compression stage of the compressor in the flow direction, is, before the second compression stage of the compressor and, subsequently, the post-cooler are passed through, taken into account with regard to a probability of overheating and/or condensate formation. Consequently, the control of the cooling device can be realized independently of possible power data or operating settings of the compressor and of the respective cooler, that is to say the respective temperature is detected directly and is not derived indirectly via other variables, which would however be possible in principle. In the case of an indirect derivation, for example in the case of a measurement of the compressor-exit temperature of the air, the further cooling by the post-cooler and/or the intermediate cooler would need to be mapped in the control apparatus, which increases the degree of complexity of the control algorithm and does not take account of deviations of the assumed cooling capacity of the post-cooler and/or intermediate cooler from the actual cooling capacity.

Through alternative or additional measurement of the oil-sump temperature, it is moreover possible, by way of control of the cooling device that is adapted thereto, to counteract ingress of water into the oil in the case of excessively low temperatures and a temperature-induced reduction in the service life of the oil.

Moreover, it may be advantageous to measure both the post-cooler exit temperature and the oil-sump temperature, so as to be able to execute control of the cooling device that is matched to both temperatures. Also, the failure of one of the temperature detection units can be compensated for by the in each case other temperature detection unit. Beside a redundant design, it is however also possible via the parallel measurements for a plausibility test to be carried out, which provides in particular information on malfunctions of the temperature detection units. This applies equally to the use of multiple sensors in a temperature detection unit. These advantages are not limited to a post-cooler exit temperature of the air and an oil-sump temperature, but apply equally to the detection by other detection units, which relates to at least two different measurement variables.

In one configuration, provision is made of the above temperature detection unit or a further temperature detection unit in the region of a post-cooler and/or of the intermediate cooler of the compressor system, in particular in the air flow on a side of the post-cooler and/or intermediate cooler that is downstream in the air-flow direction.

As already stated, taking into account the temperature in the region of the post-cooler simplifies the design of the control algorithm and increases the reliability of the control. The measurement signal obtained may be used alone or in conjunction with further measurement signals. In particular a measurement in the air flow behind the post-cooler may be advantageous with regard to the arrangement of a temperature detection unit owing to the ease of access.

The control apparatus is in particular configured to taken into account a difference matching of the post-cooler exit temperature of the air and of the oil-sump temperature with a respective predetermined limit value of the post-cooler exit temperature of the air and of the oil-sump temperature as input variable for the control of the cooling device, in particular to use the difference matching as manipulated variable for controlling an internal and external oil circuit in the case of a respective temperature difference above a predetermined limit value.

Normally, for example in the case of oil-lubricated compressors, from the attainment of a predetermined minimum limit value of the oil-sump temperature, a switch from a inner oil circuit, which does not pass through the oil cooler, to an outer oil circuit, which is routed through the oil cooler, is realized, so as not to exceed a maximum limit value of the oil-sump temperature. According to the above configuration, however, not only the oil-sump temperature but also the post-cooler exit temperature is considered for this purpose. Consequently, the switching to the outer oil circuit can not just be realized upon attainment of the minimum limit value of the oil-sump temperature, but can be delayed as long as the oil-sump temperature is below the maximum limit value of the oil-sump temperature and the post-cooler exit temperature of the air is below a predetermined limit value of the post-cooler exit temperature. Switching to the outer oil circuit is in this case provided only if one of the aforementioned criteria is not longer satisfied, that is to say the maximum limit value of the oil-sump temperature and/or the predetermined limit value of the post-cooler exit temperature are/is attained or exceeded.

In one refinement, the control apparatus is configured to take in account, for the control of the cooling device, temperature losses, in particular temperature losses via a housing, and/or thermal inertia, in particular thermal inertia associate with an oil temperature, as disturbance variables, in particular via at least one proportional element.

Temperature losses, such as via the compressor housing or post-cooler housing, and/or thermal inertia can have an interfering effect on the controlled variable. Taking into account one or more such disturbance variables allows the closed-loop control path to correspondingly adapt the manipulated variable. The use of a proportional valve makes possible a quick reaction. The proportional element may for example also be comprised by a PT1 or PT2 element or a PID controller.

In one configuration, the cooling device comprises at least one fan, in particular at least one electric fan.

As cooling device, fans can be easily integrated and retrofitted into corresponding compressor systems. If the cooling device comprises multiple fans, the cooling can be realized locally in a targeted manner and the respective cooling power can be reduced by reduction of the required air flow owing to smaller distances from the object to be cooled and/or from the air stream to be cooled.

In particular, provision is made of at least in each case one fan for an oil circuit of the compressor system and one fan for the compressed-air post-cooler and/or a compressed-air intermediate cooler.

With regard to the effects of overheating or undercooling, both the oil circuit and the compressed air are important as control or controlled variables, so that targeted local cooling by at least in each case one fan offers a quick reaction possibility for avoiding overheating. Moreover, in the context of avoiding or at least reducing condensate formation, it is advantageous if, through local cooling, the region of influence of respective fans is locally limited, in particular if these are controlled individually.

In one configuration, the control apparatus is configured to execute a run-on operation of the cooling device after the compressor has been switched to an intermittent operation, and/or not to activate, or to only partially activate, the cooling device when the compressor starts.

Accordingly, provision may be made of a run-on operation of the cooling device based on operating data and/or surroundings data, such that the cooling device continues to be operated for a predetermined length of time and/or until a predefined event occurs. A correspondingly predefined event may for example be lowering of a detected temperature by a predetermined amount or falling-below of a predetermined absolute limit temperature or of a maximum differential temperature in relation to the intake temperature. After switching of the compressor to intermittent operation, the cooling device can, over the respective length of time, continue to be operated with constant operating parameters or else follow a run-on operation-parameter scheme, for example continuously reduce the fan rotational speed in the case of a fan. Via the run-on operation, the heat capacities of various components, such as compressor block or cylinder, can be used. While the compressor is at a standstill, the heated components can continue to be cooled. Upon restart, the heating curve of the components starts at a lower point than without post-cooling. In this way, during intermittent operation, which is common in rail vehicles, the peak temperatures and the temperature level of the components are lowered overall. In this way, the thermal loads and associated thermal aging processes are avoided or at least reduced. Correspondingly, for the run-on operation, account may be taken of materials incorporated in the region to be cooled and also of temperature histories. Where thermal loads with associated aging processes cannot be completely avoided, it is possible for temperature data to be collected for servicing purposes and/or for corresponding servicing measures to be initiated based on the temperature data.

If, after the start-up of the compressor, the cooling device is not or is only partially activated, the control apparatus may provide a predetermined delay, which results in particular in a manner dependent on the operating parameters of the compressor, or couple the operation of the cooling device likewise to predefined events, such as exceedance of a temperature limit value.

In particular, the control apparatus is configured not to activate, or to only partially activate, the cooling device at least until the compressor has reached its operating temperature.

The compressor can thereby be brought quickly to the operating temperature without this being delayed by the cooling device. For this purpose, for example, a corresponding temperature, such as the component temperature of the compressor or some other temperature representing the operating temperature of the compressor, may be detected via the temperature detection unit. Alternatively or additionally, the control apparatus may provide the retention based on stored empirical values or an algorithm in dependence on the operating conditions or operating parameters for which attainment of the operating temperature can be expected. In this context, it is also possible for the compressor to be operated at an energy-optimized rotational speed, for example particularly slowly, so as to be able to overcome the inertia of the system. Alternatively, the rotational speed of the compressor may be increased and, following this, reduced for the purpose of asymptotically approaching the upper pressure point, in order in this way to delay deactivation for as long as possible.

In a further aspect, disclosed embodiments relate to a method for controlling a cooling device of a compressor system that comprises:
detecting an air temperature, oil temperature and/or component temperature of the compressor system, and
controlling the cooling device based on a detected air temperature, oil temperature and/or component temperature.

The air temperature, oil temperature and/or component temperature may for this purpose be measured via a temperature detection unit, that is to say directly, or be in particular calculated from other measurement and/or operating variables. A derivation, in contrast to a calculation, does not have to yield any quantitative specific temperature indication, but rather can classify the respective temperature qualitatively in the context of predetermined limit values, for example based on predetermined limit values of other measurement variables. Here, such a derivation may also contain calculation steps, wherein ultimately the qualitative evaluation is decisive. In contrast to this, calculation from other variables yields a quantitative result for the control of the cooling device. Specific quantitative calculation from other measurement variables may also be understood as meaning indirect measurement.

The cooling device is controlled in a manner dependent on the qualitative result of a derivation and/or on the quantitative result of a direct or indirect measurement. The mechanical decoupling and decoupling in terms of signaling of the operation of the cooling device from the compressor operation by way of the control based on detected temperatures results in the advantages already described in relation to the compressor system.

In one configuration of the method, based on the detected air temperature and/or oil temperature and/or component temperature, at least one cooling-fluid volumetric flow parameter, in particular a cooling-fluid volumetric flow rate, a cooling-fluid volumetric flow temperature, and/or a switch-on and/or switch-off instant of the cooling device, is controlled.

The cooling-fluid volumetric flow rate and/or the switch-on and/or switch-off instant of the cooling device bring(s) about a relatively low-delay influence on the temperature efficiency of the compressor system, whereas, in the case of changing of the cooling-fluid volumetric flow temperature, the corresponding fluid inertia with respect to a change in temperature is to be taken into account. However, the alternative or additional selection of the cooling-fluid volumetric flow temperature can, for example by way of a link to heat exchangers, the connection of heat exchangers and/or other configurations, provide energy-efficient cooling. Referring again to the control of the cooling-fluid volumetric flow rate and/or of the switch-on and/or switch-off instant, the change in the cooling-fluid volumetric flow rate offers the advantage that, in this case, the components of the cooling device are conserved with respect to high-frequency switch-on and switch-off operations. On the other hand, it is also possible to realize the independent control of the cooling device via switch-on and/or switch-off instants for cooling devices in the case of which a cooling-fluid volumetric flow rate cannot be adapted.

Owing to high and inexpensive availability, air is used in particular as fluid, that is to say air-cooling is provided. Use may however also be made of other fluid heat carriers, such as water or oil. In this context, it is alternatively or additionally also possible for provision to be made for the variable cooling through the use of different heat carriers with correspondingly different heat capacity and/or thermal conductivity. For this purpose, the cooling device may comprise coolers which operate with in each case different heat carriers, which are separately controllable and/or which switch between different inlets for different heat carriers. The use of different heat carriers and also the adaptation of the cooling-fluid volumetric flow temperature may, in the case of low ambient temperatures, in particular during intermittent operation of the compressor, also be used to avoid or at least to reduce condensate formation. In such a case, the cooling device operates as a heating device.

In one configuration, in particular through the control of a cooling device of a compressor system with a piston compressor, an oil temperature and/or an intermediate-cooler exit temperature and/or a post-cooler exit temperature are/is controlled based on the detected component temperature.

The component temperature, in the case of the oil temperature as controlled variable, relates in particular to a component-temperature detection at the compressor, whereas the component temperature with regard to the intermediate-cooler exit temperature and/or the post-cooler exit temperature is aimed in particular at a component-temperature detection at the intermediate cooler and/or post cooler. It is however possible for all the stated component temperatures to be measured and correspondingly taken into account in the control apparatus.

Alternatively, in particular for the control of a cooling device of a compressor system with an oil-lubricated rotary compressor, an air temperature, in particular a post-cooler exit temperature, is controlled based on the detected air temperature, in particular of a detected post-cooler exit temperature, and/or of the detected oil temperature, in particular of a detected oil-sump temperature.

Both the detected air temperature and the detected oil temperature make it possible for conclusions to be able to be drawn with regard to a risk of overheating or condensate formation. In particular, via the detected oil temperature, it is also possible to assess the probability of ingress of water into the oil. Through the use of both detected temperatures for controlling the air temperature, it is possible not only for a redundant control to be formed, but also for the air temperature to be adapted according to requirement via this. For example, the control apparatus can, for the purpose of an increase in cooling power, change at least one cooling-fluid volumetric flow parameter of the cooling device if one of the detected temperatures is above a respective predetermined limit value. Moreover, it may be provided that the change in the at least one cooling-fluid volumetric flow parameter differs according to exceedance of the respective limit value by the detected air temperature or exceedance of the respective limit value by the detected oil temperature, for example the cooling power is increased to a significantly greater extent in the case of exceedance of the air-temperature limit value than in the case of exceedance of the oil-temperature limit value, or vice versa.

In one refinement, a difference matching of the detected air temperature and of the detected oil temperature is realized as manipulated variable for a control between an internal and an external oil circuit in the case of a temperature difference above a predetermined limit value.

This results in the advantages already described in relation to the compressor system.

In a further aspect, during the control, temperature losses, in particular temperature losses via a housing, and/or thermal inertia, in particular thermal inertia associate with an oil temperature, are taken into account as disturbance variables, in particular via a proportional element.

The advantages result here likewise analogously to the embodiments specified in relation to the compressor system. Moreover, different temperature losses and/or thermal inertia can be weighted differently by the control apparatus, in order to adapt the control of the cooling device according to requirement.

Furthermore, the disclosed embodiments relate to a computer program product having a program code which is stored on a machine-readable medium and which is configured such that, when executed on a data-processing apparatus, the data-processing apparatus causes the above-described method to be carried out.

Via the computer program product, it is inter alia easily possible for cooling devices, controlled in terms of signaling, of conventional compressor systems to be retrofitted.

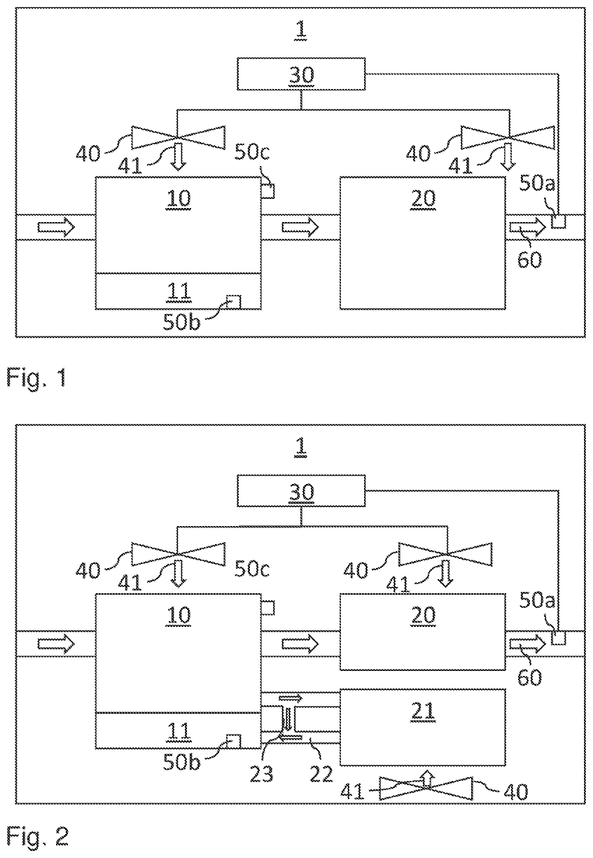

With this understanding in mind, FIG. 1 shows a schematic illustration of a compressor system 1 with a compressor 10 and a post-cooler 20 according to a first embodiment. According to the arrows, the air to be compressed is firstly guided through the compressor 10 and compressed there and subsequently passes through the post-cooler 20. The compressor system 1 moreover comprises an control apparatus 30 which controls the cooling device, which cooling device has two fans 40 in the present embodiment. Both fans, during operation, can each generate a cooling-air volumetric flow 41 which, via one fan 40, is directed primarily at the compressor 10 and/or at the compressor outlet and, via the other fan 40, is directed primarily at the post-cooler outlet and/or at the post-cooler 20. Here, the control apparatus 30 is configured in such a way that it can adapt both the switch-on and switch-off instants of the fan 40 and the cooling-air volumetric flow rate of the fan 40 through control of the fan rotational speed.

In the present embodiment, the control of the fans 40 is based on an evaluation of the temperatures detected by the temperature detection units 50a, 50b, 50c. The temperature detection unit 50a detects a post-cooler exit temperature, the temperature detection unit 50b detects an oil-sump temperature of the oil sump 11 of the compressor 10, and the temperature detection unit 50c detects a component temperature of the compressor 10. The temperature detection units 50a, 50b, 50c may be both connected to the control apparatus 30 via lines, as is shown for the temperature detection unit 50a, and configured for wireless communication with the control apparatus 30, as is illustrated in FIG. 1 for the temperature detection units 50b, 50c through omission of the connecting line. If one of the detected temperatures exceeds an in each case predetermined limit value, then the fans 40 are switched on independently of the operation of the compressor. If, by contrast, at least one of the detected temperatures falls below the respective limit values for the detected post-cooler exit temperature, the detected oil-sump temperature and/or the detected component temperature, the fans 40 are switched off. Here, the fans 40 are controlled according to requirement individually, wherein for simplifying the control, synchronous control may also be provided. In the latter case, for more precise cooling management, various limit-value constellations may be stored in the control apparatus 30. Moreover, the control apparatus 30 can adapt the cooling power of the fans 40 in a temperature-dependent manner through control of the fan rotational speed.

Even though the fans 40 in the present embodiment are controlled via the detected post-cooler exit temperature, the detected oil-sump temperature and the detected component temperature, the control apparatus 30 may alternatively or additionally also be configured to continue operating the fans, at least for a predetermined length of time, after the compressor is switched to an intermittent operation, that is to say to provide a run-on operation. Such a run-on operation may also be linked to the magnitude of the temperature detected at the deactivation instant such that the run-on operation is provided only above the predetermined temperature limit value and/or the duration of the run-on operation depends on such a temperature.

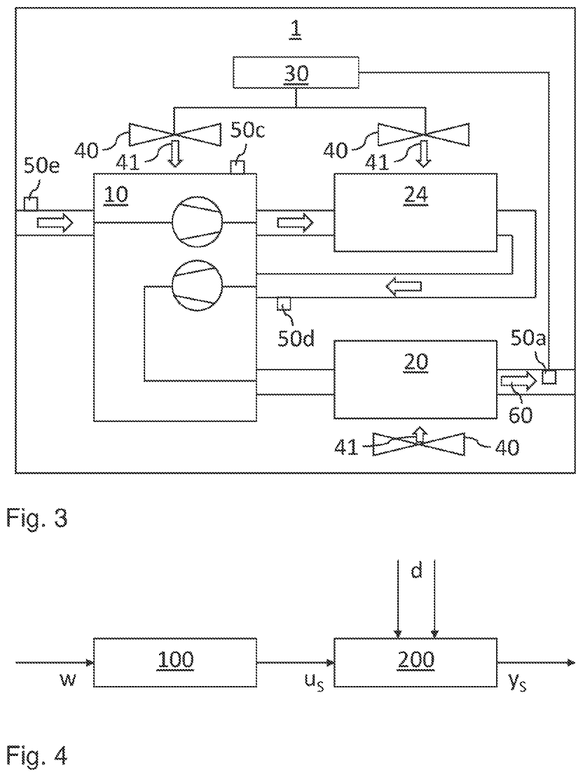

FIG. 2 shows by way of example an oil-lubricated compressor as an exemplary second embodiment of the compressor system 1. Here, as in FIG. 3 too, the same reference signs are used for identical components. The second embodiment differs from the first embodiment by the provision of an inner oil circuit 23 and of an outer oil circuit 22 which is routed through an oil cooler 21. The oil cooler 21, like the compressor 10 and the post-cooler 20, is cooled according to requirement by a fan 40. The fan 40 assigned to the oil cooler 21 is likewise controlled by the control apparatus 30, although the coupling in terms of signaling has not been indicated here for reasons of clarity. For the switching of the oil guidance from the inner oil circuit 23 to the outer oil circuit 22, in which the oil passes through the oil cooler 21, account is taken of the post-cooler exit temperature detected by the temperature detection unit 50a and the oil-sump temperature detected by the temperature detection unit 50b. As long as the oil-sump temperature does not exceed a predetermined maximum limit value and also the post-cooler exit temperature remains below a predetermined limit value, the oil is conducted into the oil sump 11 via the inner oil circuit 23. If one of the criteria is not satisfied, the switching to the outer oil circuit takes place. Correspondingly, with the switching to the outer oil circuit, the fan 40 assigned to the oil cooler 21 is activated. Activation may however also be linked to other events, such as to a detected oil-sump temperature, a temperature of the oil cooler, or run-on or preliminary-running operations to be provided.

As a third embodiment, FIG. 3 shows by way of example a compressor system 1 with a two-stage compressor as a compressor 10. The process air 60 firstly passes through the first compression stage of the compressor 10, in order then to be conducted into an intermediate cooler 24. The intermediate-cooler exit temperature is in this case detected via the temperature detection unit 50d. The process air 60, after passing through the intermediate cooler 24, is fed to the second compression stage of the compressor 10 and is subsequently discharged via the post-cooler 20.

FIG. 3 moreover also shows by way of example a temperature detection unit 50e for detecting an intake temperature or ambient temperature, as can also be applied in the previous embodiments. The detected intake temperature may be used for the provision of a run-on operation of the cooling device that is based on operating data and/or surroundings data, such that the cooling device continues to be operated for a predetermined length of time and/or until a predefined event occurs. A correspondingly predefined event may for example be falling-below of a maximum differential temperature with respect to the intake temperature.

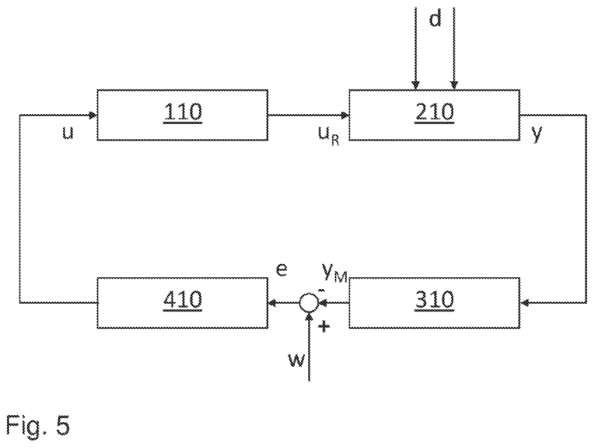

FIG. 4 shows an exemplary open-loop control of a cooling device, which can be applied to a compressor system as per FIGS. 1 to 3. Such an open-loop control generally comprises an actuator 100 and an open-loop control path 200, wherein the open-loop control controls the variable yS to be controlled according to a reference variable w and a manipulated variable uS and with account taken of possible disturbance variables d. When applied to the first embodiment shown in FIG. 1, for example the air temperature is controlled, as variable yS to be controlled, via the cooling-air volumetric flow provided by the fan 40, as manipulated variable uS, and with account taken of the temperature losses and thermal inertia, as disturbance variables d. By contrast to the exemplary closed-loop control illustrated in FIG. 5, the open-loop control is realized here in an event-based manner, for example according to the exceedance or falling-below of an in each case predetermined limit value of the detected temperatures. The control of the fans is then realized based on predetermined control specifications, whereas, with the closed-loop control, the control specifications are adapted by the control apparatus 30 according to ascertained control differences.

The closed-loop control correspondingly shown in FIG. 5 comprises an actuator 110, a closed-loop control path 210, a measuring element 310 and a closed-loop controller 410. When applied to the control apparatus 30 of the compressor system 1 according to the embodiment illustrated in FIG. 1, the post-cooler exit temperature of the air and the oil-sump temperature are measured as controlled variables y and the difference between the respective reference variable w and the ascertained actual value yM is formed. From the control difference e, the control variable u is transferred to the actuator 110 via the closed-loop controller 410. The manipulated variable uR, for example the fan rotational speed in this case, then in turn enters the closed-loop control path, which in turn takes into account the temperature losses and the thermal inertia, as disturbance variables d.

If the fans 40 or their respective fan rotational speeds are controlled independently of one another, a separate closed-loop control circuit may be provided for each of the fans. Equally, however, the closed-loop control may also, according to embodiments above, control the fans jointly first of all, in particular with equal fan rotational speed, and make respective independent adaptations in a manner dependent on a difference of the controlled variables from one another. In this case, the control difference of the difference between the controlled variables and the reference variable of this difference between the controlled variables likewise enters the closed-loop control, that is to say the difference between the controlled variables gives rise, in a manner dependent on their control difference, to an independent control of the fans 40. The difference between the controlled variables, that is to say the difference between the post-cooler exit temperature and the oil-sump temperature in this case, may moreover also be used to control the internal and external oil circuits of the compressor 10 as second manipulated variable.

The invention is not limited to the embodiments described. Although the cooling device has been described based on the use of fans, use may be made of other cooling units, such as heat exchangers, at which the air in the compressor system is made to pass by and/or pass through. The cooling power of the heat exchangers can be adapted by way of their positioning, orientation, and/or, in the case of heat carriers flowing through the heat exchanger, by way of the cooling-fluid volumetric flow rate, the cooling-fluid volumetric flow temperature and/or changing of the heat carrier.

### LIST OF REFERENCE SIGNS

1 Compressor system

### 10 Compressor

11 Oil sump

### 20 Post-cooler

21 Oil cooler
22 Outer oil circuit
23 Inner oil circuit
24 Intermediate cooler
30 Control apparatus

### 40 Fan

51 Cooling-air volumetric flow
50a Temperature detection unit (post-cooler exit temperature)
50b Temperature detection unit (oil-sump temperature)
50c Temperature detection unit (component temperature)
50d Temperature detection unit (intermediate-cooler exit temperature)
50e Temperature detection unit (intake temperature/ambient temperature)
60 Process-air flow

### 100, 110 Actuator

200 Open-loop control path
210 Closed-loop control path
310 Measuring element
410 Closed-loop controller
d Disturbance variable(s)
e Control difference
u Control variable
u_{R}, u_{S} Manipulated variable
y Controlled variable
y_{M} Actual value
y_{S} Variable to be controlled
w Reference variable

1. A compressor system for a rail vehicle, the compressor system having:
a compressor,
a cooling device, and
a control apparatus or an interface for receiving control signals of a control apparatus,
wherein the control apparatus is configured to control the cooling device independently of operation of the compressor to provide a cooling-air volumetric flow rate that is predefined as a manipulated variable by the control apparatus.

2. The compressor system of claim 1, wherein the control apparatus is a central control apparatus of the compressor system, or the compressor system has an interface for receiving control signals of a central control apparatus of the rail vehicle.

3. The compressor system of claim 1, further comprising a temperature detection unit for detecting an air temperature and/or oil temperature and/or component temperature, wherein the control apparatus is configured to control the cooling device based on a temperature detected by the temperature detection unit.

4. The compressor system of claim 3, wherein the compressor system comprises a post-cooler and/or an intermediate cooler that are/is arranged downstream of the compressor in the flow direction of the air flowing through the compressor, and
wherein the control apparatus is configured to control the cooling device based on a post-cooler exit temperature and/or an intermediate-cooler exit temperature of the air and/or an oil-sump temperature.

5. The compressor system of claim 4,
wherein provision is made of the temperature detection unit or a further temperature detection unit in the region of the post-cooler and/or of the intermediate cooler of the compressor system as claimed in claim 4, in the air flow on that side of the post-cooler and/or intermediate cooler which is downstream in the air-flow direction.

6. The compressor system of claim 4,
wherein the control apparatus is configured to taken into account a difference matching of the post-cooler exit temperature of the air and of the oil-sump temperature with a respective predetermined limit value of the post-cooler exit temperature of the air and of the oil-sump temperature as input variable for the control of the cooling device by using the difference matching as manipulated variable for controlling an internal and external oil circuit in the case of a respective temperature difference above a predetermined limit value.

7. The compressor system of claim 1,
wherein the control apparatus is configured to take in account, for the control of the cooling device, temperature losses, in particular temperature losses via a housing, and/or thermal inertia, in particular thermal inertia associate with an oil temperature, as disturbance variables, in particular via at least one proportional element.

8. The compressor system of claim 1,
wherein the cooling device comprises at least one electric fan for each of an oil circuit of the compressor system and for a compressed-air post-cooler and/or a compressed-air intermediate cooler.

9. The compressor system of claim 1,
wherein the control apparatus is configured to execute a run-on operation of the cooling device after the compressor has been switched to an intermittent operation, and/or not to activate, or to only partially activate, the cooling device when the compressor starts.

10. A method for controlling a cooling device of a compressor system that includes a compressor, the cooling device and a control apparatus or an interface for receiving control signals of a control apparatus, wherein the control apparatus is configured to control the cooling device independently of operation of the compressor to provide a cooling-air volumetric flow rate that is predefined as a manipulated variable by the control apparatus, the method comprising:
detecting an air temperature, oil temperature and/or component temperature of the compressor system, and
controlling the cooling device based on a detected air temperature, oil temperature and/or component temperature.

11. The method of claim 10,
wherein, on the basis of the detected air temperature, oil temperature and/or component temperature, a cooling-fluid volumetric flow rate, a cooling-fluid volumetric flow temperature, and/or a switch-on and/or switch-off instant of the cooling device, is controlled.

12. The method of claim 11,
wherein, through the control of the cooling device of the compressor system with a piston compressor, an oil temperature and/or an intermediate-cooler exit temperature and/or a post-cooler exit temperature are/is controlled on the basis of the detected component temperature, or
wherein, through the control of the cooling device of the compressor system with an oil-lubricated rotary compressor, an air temperature, in particular a post-cooler exit temperature, is controlled on the basis of a detected post-cooler exit temperature, and/or of the detected oil temperature of a detected oil-sump temperature.

13. The method of claim 12, wherein a difference matching of the detected air temperature and of the detected oil temperature with a respective predetermined limit value of the post-cooler exit temperature of the air and of the oil-sump temperature is realized as manipulated variable for a control between an internal and an external oil circuit in the case of a temperature difference above a predetermined limit value.

14. The method of claim 10,
wherein, during the control, temperature losses via a housing, and/or thermal inertia associated with an oil temperature, are taken into account as disturbance variables (d) via a proportional element.

15. A non-transitory computer readable medium including computer program code which is configured such that, when executed on a data-processing apparatus, the data-processing apparatus causes the method of claim 10 to be carried out.

16. The compressor system of claim 9, wherein the control apparatus is configured to not activate, or to only partially activate, the cooling device following starting of the compressor at least until the compressor has reached its operating temperature.
